(19) United States
(12) Patent Application Publication
(10) Pub. No.: US 2018/0366071 A1
(43) Pub. Date: Dec. 20, 2018

(54) METHOD FOR ADJUSTING COLOR TEMPERATURE BASED ON SCREEN BRIGHTNESS, NON-TRANSITORY COMPUTER-READABLE STORAGE MEDIUM AND TERMINAL DEVICE

(71) Applicant: GUANGDONG OPPO MOBILE TELECOMMUNICATIONS CORP., LTD., Dongguan (CN)

(72) Inventor: Yongxing CHEN, Dongguan (CN)

(73) Assignee: GUANGDONG OPPO MOBILE TELECOMMUNICATIONS CORP., LTD., Dongguan (CN)

(21) Appl. No.: 15/997,624

(22) Filed: Jun. 4, 2018

(30) Foreign Application Priority Data
Jun. 19, 2017 (CN) 201710465586.2

(51) Int. Cl. G09G 3/34

(52) U.S. Cl. CPC G09G 3/3406; G09G 2320/0666; G09G 2320/0626

(57) ABSTRACT

A method and an apparatus for adjusting color temperature based on screen brightness and a terminal device are provided. The method includes: detecting current screen brightness of a screen subjected to a blue light filtering operation; determining a reconstruction proportion of RGB optical spectral energy corresponding to the current screen brightness and a target color temperature to be met according to pre-learned RGB optical spectral energy distribution information; and adjusting the RGB optical spectral energy according to the reconstruction proportion, so as to enable the RGB optical spectral energy of the screen subjected to a blue light filtering operation to meet the target color temperature.

### CROSS-REFERENCE TO RELATED APPLICATIONS

This application is based on and claims priority of Chinese Patent Application No. 201710465586.2, filed on Jun. 19, 2017, the entire contents of which are incorporated herein by reference.

### FIELD

The present disclosure relates to screen display technologies, and more particularly to a method for adjusting color temperature based on screen brightness, an apparatus for adjusting color temperature based on screen brightness, and a terminal device.

### BACKGROUND

At present, a screen of a terminal device typically presents different colors by overlaying three colors of red color, green color and blue color. The blue color refers to short-wavelength blue light, which may cause eye diseases such as maculopathy etc. Thus, many manufacturers would like to protect eyes from disease by blue light filtering.

### DISCLOSURE

Accordingly, the present disclosure is related to provide a method for adjusting color temperature based on screen brightness, a terminal device and a non-temporary computer readable storage medium.

Embodiments of the present disclosure provide a method for adjusting color temperature based on screen brightness, including: detecting a screen brightness of a screen subjected to a blue light filtering operation; determining a reconstruction proportion of RGB optical spectral energy corresponding to the screen brightness and a target color temperature to be met according to pre-learned RGB optical spectral energy distribution information; and adjusting the RGB optical spectral energy of the screen according to the reconstruction proportion, so as to make the RGB optical spectral energy of the screen subjected to the blue light filtering operation meet the target color temperature.

Embodiments of the present disclosure provide a non-transitory computer readable storage medium having a computer program stored thereon. When the processor executes the computer program, the device is caused to perform the method for adjusting color temperature based on screen brightness as mentioned above.

Embodiments of the present disclosure provide a terminal device, including a memory, a processor and a computer program stored on the memory and executable on the processor. When the processor executes the computer program, the terminal device is caused to perform the method for adjusting color temperature based on screen brightness as mentioned above.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings.

FIG. 1 is a flow chart of a method for adjusting color temperature based on screen brightness according to an embodiment of the present disclosure.

FIG. 2 (a) is a schematic diagram illustrating spectrograms with respect to a color temperature parameter of a screen according to an embodiment of the present disclosure.

FIG. 2 (b) is a schematic diagram illustrating spectrograms with respect to a color temperature parameter of a screen according to another embodiment of the present disclosure.

FIG. 3 is a flow chart of a method for adjusting color temperature based on screen brightness according to a specific embodiment of the present disclosure.

FIG. 4 is a block diagram of an apparatus for adjusting color temperature based on screen brightness according to an embodiment of the present disclosure.

FIG. 5 is a block diagram of an apparatus for adjusting color temperature based on screen brightness according to another embodiment of the present disclosure.

FIG. 6 is a block diagram of an apparatus for adjusting color temperature based on screen brightness according to a further embodiment of the present disclosure.

FIG. 7 is a block diagram of a terminal device according to an embodiment of the present disclosure.

### EMBODIMENTS OF THE PRESENT DISCLOSURE

Reference will now be made in detail to exemplary embodiments, examples of which are illustrated in the accompanying drawings, in which the same or similar reference numbers throughout the drawings represent the same or similar elements or elements having same or similar functions. Embodiments described below with reference to drawings are merely exemplary and used for explaining the present disclosure, and should not be understood as limitation to the present disclosure.

A method for adjusting color temperature based on screen brightness, an apparatus for adjusting color temperature based on screen brightness, and a terminal device according to embodiments of the present disclosure will be described below with reference to accompanying drawings.

After a part of blue light is filtered, since screen brightness is consisted of RGB proportion, the screen brightness in addition to color of the screen may change obviously after a part of blue light is filtered out when adjusting color temperature. During the actual operation, the screen brightness changes, while the color temperature of the screen changes accordingly. The color temperature may change in a range of 600-700K, such that the adjustment result of color temperature may not conform to expectation, i.e., there may be obvious errors.

After a part of blue light (B) is filtered out, the screen brightness may be reduced. For example, for a display screen of a terminal device, a relationship between the brightness Y of the display screen and the proportion of red light, greed light and blue light (RGB) may be expressed as Y=0.299*R+0.587*G+0.114*B, it can be seen from the formula that, if the blue light (B) is filtered out, the value of Y is reduced. However, different screen brightness may have different effects on the optical spectral energy distribution in the color configuration of the color temperature, such that there may be difference between viewed color temperature and expected color temperature, i.e., a shift in color temperature may occur.

In order to solve the above technical problems, the present disclosure provides a method for adjusting color temperature based on screen brightness, which may avoid the effect of change in the screen brightness on the color temperature, such that the visual experience of the user can be improved.

In the following, the method for adjusting color temperature based on screen brightness provided by the present disclosure will be described in combination with specific embodiments. An execution subject of the method for adjusting color temperature based on screen brightness provided by the present disclosure refers to an apparatus for adjusting color temperature based on screen brightness. The apparatus for adjusting color temperature based on screen brightness may be a terminal device having a display screen, such as a mobile phone, a computer, a PAD, a wearable device or the like, which may be selected according to application requirements.

FIG. 1 illustrates a flow chart of a method for adjusting color temperature based on screen brightness according to an embodiment of the present disclosure.

As illustrated in FIG. 1, the method includes the following.

At block S110, current screen brightness of a screen subjected to a blue light filtering operation is detected.

After the blue light filtering operation, the screen brightness of the screen may change. In this case, the situation of the current screen brightness may be obtained by detecting the current screen brightness of the screen subjected to the blue light filtering operation.

In different application scenarios, different methods can be used to obtain the current screen brightness of the screen subjected to the blue light filtering operation, which will be described below.

First Instance

In this instance, the screen brightness is obtained according to a screen brightness formula. For example, the screen brightness Y and the proportion of RGB may be expressed as Y=0.299*R+0.587*G+0.114*B. After the color temperature is adjusted, the changed proportion of B is substituted into the above formula to obtain the current screen brightness.

Second Instance

The current screen brightness of the screen subjected to the blue light filtering operation may be obtained via a related brightness sensor.

At block S120, a reconstruction proportion of RGB optical spectral energy corresponding to the current screen brightness and a target color temperature to be met is determined according to pre-learned RGB optical spectral energy distribution information.

The target color temperature may be the screen color temperature corresponding to a display effect of the desired screen color temperature.

The screen brightness and the screen color temperature are bound correspondingly in advance. The reconstruction proportion of RGB optical spectral energy required for the display effect of each color temperature under certain screen brightness level may be learned and stored in advance. As shown in table 1, in an example, the screen brightness is 5 nit, the screen color temperature may be adjusted in a range of 2000 K-10000 K. After the pre-learning, the proportion of RGB optical spectral energy required for the display effect of each screen color temperature can be obtained under the screen brightness of 5 nit.

5 nit RGB optical spectral energy distribution

| proportion | | | |
|---|---|---|---|
| color temperature | R | G | B |
| 2000K | a1 | b1 | c1 |
| 2001K | a2 | b2 | c2 |
| . | . | . | . |
| . | . | . | . |
| . | . | . | . |
| 10000K | a500 | b500 | c500 |

The reconstruction proportion corresponding to the current screen brightness and the target color temperature to be met is determined according to pre-learned RGB optical spectral energy distribution information. For example, when the current screen brightness is 5 nit, if the target color temperature is 2000 K, the corresponding reconstruction proportion of RGB optical spectral energy may be a1:b1:c1, which may be the RGB optical spectral energy distribution proportion corresponding to the target color temperature to be met.

The RGB optical spectral energy distribution proportion corresponding to the current screen brightness and the target color temperature to be met determined according to pre-learned RGB optical spectral energy distribution information may be different from the initial RGB optical spectral energy distribution proportion of the screen subjected to the blue light filtering operation, such that the determined RGB optical spectral energy distribution proportion may be called as the reconstruction proportion of RGB optical spectral energy for distinguishing.

In different application scenarios, different methods can be used to learn the RGB optical spectral energy distribution information, which will be described below.

First Instance

The RGB optical spectral energy of the screen in the initial state is adjusted according to a predetermined color temperature until the predetermined color temperature is met. The RGB optical spectral energy of the screen in the initial state is adjusted by energy adjusting modules corresponding respectively to the blue light, green light and red light. The current color temperature is obtained according to the adjusted RGB optical spectral energy of the screen, and it is determined whether the current color temperature meets the predetermined color temperature. If the current color temperature does not meet the predetermined color temperature, the RGB optical spectral energy is adjusted continually until the predetermined color temperature is met.

The test data recorded in the RGB optical spectral distribution information may include a correspondence between the predetermined screen brightness level, the predetermined color temperature and a reconstruction proportion of RGB optical spectral energy.

Second Instance

The display effect of color temperature caused by each reconstruction proportion of RGB optical spectral energy can be obtained under each brightness level. After the user feels the different color temperatures, evaluation information that the user feeds back to the different color temperatures is received and the RGB optical spectral energy distribution information corresponding to each color temperature can be obtained and recorded.

In different application scenarios, different methods can be adopted to determine the reconstruction proportion of RGB optical spectral energy corresponding to the screen brightness and the target color temperature to be met according the pre-learned RGB optical spectral energy distribution information.

As a possible embodiment, in an ideal state in which the reconstruction proportion of RGB optical spectral energy corresponding to each screen color temperature is learned for each brightness level, there may be a huge calculated amount. For example, if the screen has 255 screen brightness levels, the reconstruction proportions of RGB optical spectral energy for the 255 screen brightness levels are learned, which may cause a large computing pressure for the system.

In this embodiment, a screen brightness range is detected. A plurality of brightness ranges are determined according to a predetermined number of ranges and the screen brightness range. In other words, the brightness ranges are partitioned in advance according to the screen brightness which can be displayed on the screen. For example, when there are 255 screen brightness levels, three brightness ranges corresponding to three screen brightness level ranges 0-80, 81-160, and 161-255 can be obtained. The number of brightness ranges can be set according to system processing ability. For each brightness range, a reference brightness is set. For example, a middle brightness in each brightness range is configured as the reference brightness. For another example, an average value of all screen brightness included in each brightness range can be configured as the reference brightness, and then the reference brightness is learned.

The pre-partitioned brightness ranges are queried to determine a target brightness range including the current screen brightness and the reference brightness corresponding to the target brightness range. The pre-learned RGB optical spectral energy distribution information is searched to obtain the reconstruction proportion of RGB optical spectral energy corresponding to the reference brightness and the target color temperature.

In this embodiment, for example, the current screen brightness of the screen subjected to the blue light filtering operation is detected as 100 nit, and the target color temperature is n K. After searching for the predetermined brightness ranges, the target brightness range including the current screen brightness is determined as the brightness range corresponding to the brightness level range of 1-120, and the reference brightness corresponding to the brightness range is 60 nit. In this case, the reconstruction proportion of RGB optical spectral energy corresponding to the reference brightness 60 nit and target color temperature n K can be obtained by querying the pre-learned RGB optical spectral energy distribution information.

At block S130, the RGB optical spectral energy is adjusted according to the reconstruction proportion to enable the RGB optical spectral energy of the screen subjected to the blue light filtering operation to meet the target color temperature.

In some embodiments, the RGB optical spectral energy is adjusted according to the reconstruction proportion of RGB optical spectral energy, to ensure that the RGB optical spectral energy of the screen subjected to the blue light filtering operation meets the target color temperature, such that display error of the screen color temperature can be avoided and the display effect of the screen color temperature may conform to expectation.

In different application scenarios, different ways may be adopted to adjust the RGB optical spectral energy according to the reconstruction proportion of RGB optical spectral energy, to ensure that the RGB optical spectral energy of the screen subjected to the blue light filtering operation meets the target color temperature.

As a possible embodiment, a rough adjustment and a refine adjustment are performed on the RGB optical spectral energy.

In this embodiment, an initial adjustment is performed on the RGB optical spectral energy by a plurality of first energy adjusting modules corresponding respectively to blue light, green light and red light according to the reconstruction proportion. A corrected adjustment is performed, by a plurality of second energy adjusting modules corresponding respectively to blue light, green light and red light, on the RGB optical spectral energy adjusted by the plurality of first energy adjusting modules, so as to enable the RGB optical spectral energy of the screen subjected to the blue light operation to meet the target color temperature.

For example, after determining the reconstruction proportion of RGB optical spectral energy as a reconstruction proportion corresponding to the color temperature of 2570 K, in order to relief pressure of adjustment, the color temperature is firstly adjusted to the reconstruction proportion corresponding to the color temperature of 2500 K and further the proportion of the RGB optical spectral energy is adjusted to make the color temperature reach 2570 K.

The adjustment procedure including the rough adjustment and refine adjustment may be repeatedly executed many times, until the target temperature is met.

As another embodiment, the RGB optical spectral energy is directly adjusted according to the calculated reconstruction proportion of the RGB optical spectral energy, in which skilful operational experience and energy adjusting modules each having high performance are required.

In this embodiment, according to the reconstruction proportion of the RGB optical spectral energy, the RGB optical spectral energy is adjusted by the energy adjusting modules corresponding respectively to blue light, green light and red light, to ensure that the RGB optical spectral energy of the screen subjected to the blue light filtering meets the target color temperature.

The above energy adjusting module may be an energy adjustor, or an energy adjusting program able to realize the RGB optical spectral energy adjustment, which is not limited herein.

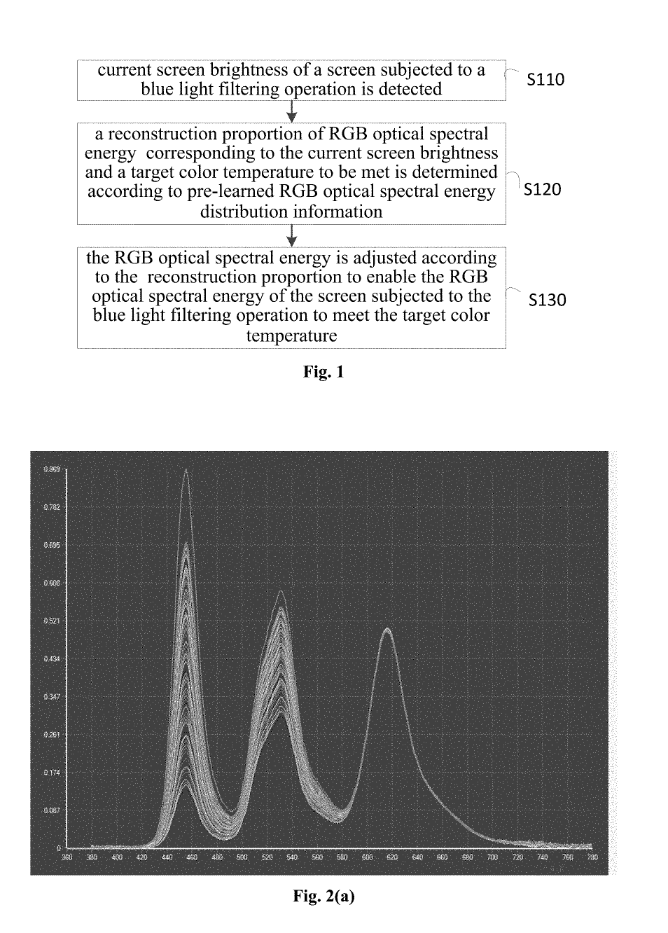

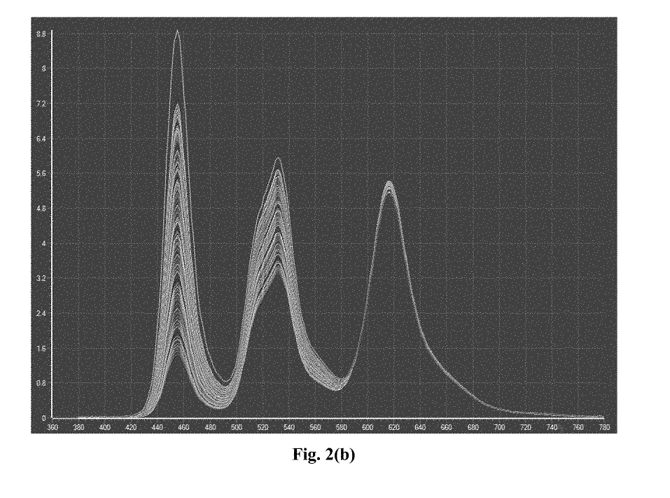

With the method for adjusting color temperature based on screen brightness, on the basis of the fact that different current screen brightness may have different effects on the RGB optical spectral energy, the reconstruction proportion of the RGB optical spectral energy required for each screen color temperature can be learned under different screen brightness, such that corresponding reconstruction proportions of the RGB optical spectral energy can be set correspondingly under different screen brightness, thus avoiding the shift in the screen color temperature. It can be seen from the spectrograms with respect to color temperature as illustrated in FIG. 2(a) and FIG. 2(b) that, in FIG. 2(a) which illustrates the spectrograms with respect to a color temperature parameter under a low brightness level, the maximum power on the vertical axis is 0.086, in FIG. 2(b) which illustrates the spectrograms with respect to a color temperature parameter under a high brightness level, the maximum power on the vertical axis is 8.8.

By matching the reconstruction proportion of RGB optical spectral energy for multiple screen brightness, the screen color temperature for different brightness can be obtained accurately, such that the color of the screen is more natural compared to the situation in which a large error occurs, and the blue light is filtered out to avoid harm of blue light, thus enhancing the immunologic function, reagency, retention and coordinate ability, and reducing possibility of diabetes mellitus, heart disease, cancer, obesity, dyspepsia, constipation, tristimania or the like.

In order to make those skilled understand the present disclosure clearer, the execution procedure of the method for adjusting color temperature based on screen brightness will be described below in combination with a specific application scenario.

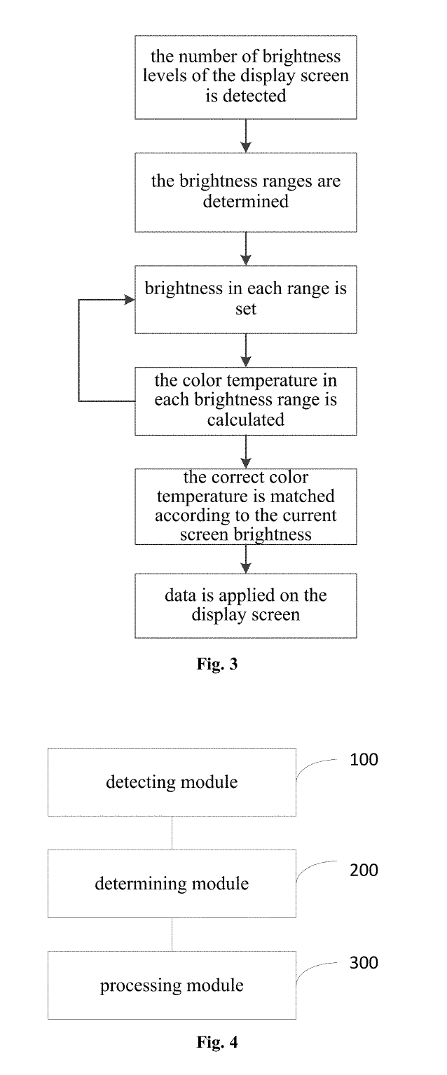

As illustrated in FIG. 3, the number of brightness levels of the display screen is detected. For example, the number of brightness levels of the display screen is 255. The screen brightness can be determined according to practical tests. The number of brightness ranges corresponding to the 255 brightness levels can be determined according to the screen brightness. For example, three brightness ranges are set. For a brightness range, a middle value in the brightness range can be configured as the reference brightness of the brightness range, and the color temperature parameter (RGB optical spectral energy reconstruction proportion) for each reference brightness can be calculated. The RGB optical spectral energy of the screen can be adjusted according to the reconstruction proportion of the RGB optical spectral energy.

In conclusion, with the method for adjusting color temperature based on screen brightness, current screen brightness of a screen subjected to a blue light filtering operation is detected, a reconstruction proportion of RGB optical spectral energy corresponding to the current screen brightness and a target color temperature to be met is determined according to pre-learned RGB optical spectral energy distribution information, and the RGB optical spectral energy is adjusted according to the RGB optical spectral energy reconstruction proportion, to enable the RGB optical energy of the screen subjected to a blue light filtering operation to meet the target color temperature. In this way, a shift in the color temperature is avoided by setting the color temperature and the screen brightness correspondingly, such that the adjustment result of the color temperature conforms to the expectation, thus improving visual experience of the user.

In order to achieve the above objectives, the present disclosure further provides an apparatus for adjusting color temperature based on screen brightness.

FIG. 4 illustrates a block diagram of an apparatus for adjusting color temperature based on screen brightness according to an embodiment of the present disclosure.

As illustrated in FIG. 4, the apparatus includes a detecting module 100, a determining module 200 and a processing module 300.

The detecting module 100 is configured to detect current screen brightness of a screen subjected to a blue light filtering operation.

The determining module 200 is configured to determine a reconstruction proportion of RGB optical spectral energy corresponding to the current screen brightness and a target color temperature to be met according to pre-learned RGB optical spectral energy distribution information.

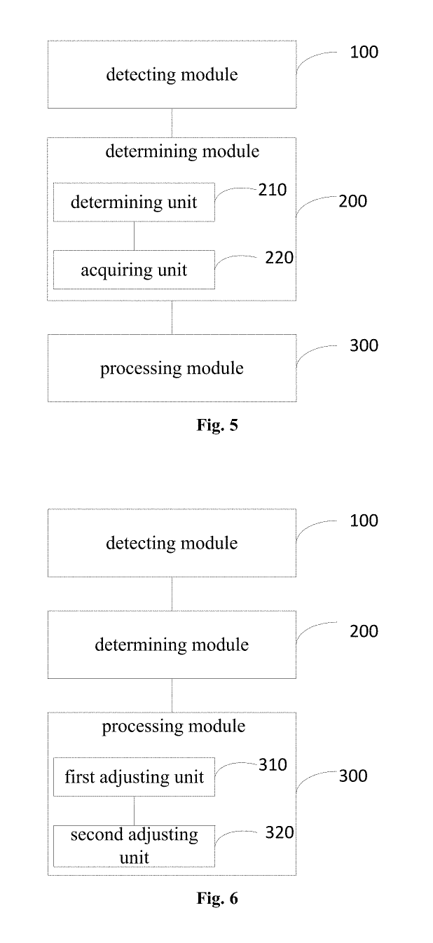

In an embodiment of the present disclosure, as illustrated in FIG. 5, on the basis of the embodiment described with regard to FIG. 4, the determining module 200 includes a determining unit 210 and an acquiring unit 220.

The determining unit 210 is configured to query a plurality of brightness ranges partitioned in advance, and to determine a target brightness range including the current screen brightness and a reference brightness corresponding to the target brightness range.

The acquiring unit 220 is configured to query pre-learned RGB optical spectral energy distribution information, and to acquire the reconstruction proportion corresponding to the reference brightness and the target color temperature.

The processing module 300 is configured to adjust the RGB optical spectral energy according to the reconstruction proportion, so as to enable the RGB optical spectral energy of the screen subjected to a blue light filtering operation to meet the target color temperature.

In an embodiment of the present disclosure, as illustrated in FIG. 6, on the basis of the embodiment described with regard to FIG. 4, the processing module 300 includes a first adjusting unit 310 and a second adjusting unit 320.

The first adjusting unit 310 is configured to perform by a plurality of first energy adjusting modules corresponding respectively to blue light, green light and red light according to the reconstruction proportion, an initial adjustment on the RGB optical spectral energy.

The second adjusting unit 320 is configured to perform by a plurality of second energy adjusting modules corresponding respectively to blue light, green light and red light, a further adjustment on the RGB optical spectral energy adjusted by the plurality of first energy adjusting modules.

The description of the method for adjusting color temperature based on screen brightness mentioned above is also suitable to the apparatus for adjusting color temperature based on screen brightness, and the principles are the same, which will not be described herein.

With the apparatus for adjusting color temperature based on screen brightness, current screen brightness of a screen subjected to a blue light filtering operation is detected, a reconstruction proportion of RGB optical spectral energy corresponding to the current screen brightness and a target color temperature to be met is determined according to pre-learned RGB optical spectral energy distribution information, and the RGB optical spectral energy is adjusted according to the RGB optical spectral energy reconstruction proportion, to enable the RGB optical energy of the screen subjected to a blue light filtering operation to meet the target color temperature. In this way, a shift in the color temperature is avoided by setting the color temperature and the screen brightness correspondingly, such that the adjustment result of the color temperature conforms to the expectation, thus improving visual experience of the user.

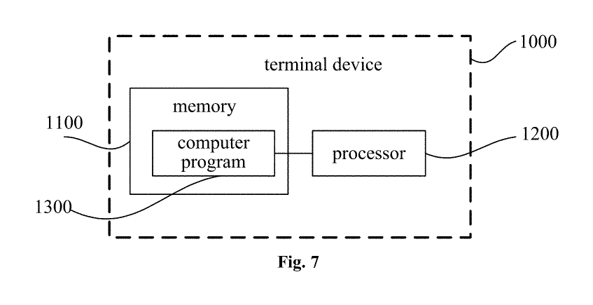

In order to achieve the above embodiments, the present disclosure further provides a terminal device. FIG. 7 illustrates a block diagram of a terminal device according to an embodiment of the present disclosure. As illustrated in FIG. 7, the terminal device 1000 may include a memory 1100, a processor 1200, and a computer program 1300 stored on the memory 1000 and executable on the processor 1200. The processor 1200 executes the computer program 1300, the method for adjusting color temperature based on screen brightness mentioned above can be realized.

In conclusion, with the terminal device, current screen brightness of a screen subjected to a blue light filtering operation is detected, a reconstruction proportion of RGB optical spectral energy corresponding to the current screen brightness and a target color temperature to be met is determined according to pre-learned RGB optical spectral energy distribution information, and the RGB optical spectral energy is adjusted according to the RGB optical spectral energy reconstruction proportion, to enable the RGB optical energy of the screen subjected to a blue light filtering operation to meet the target color temperature. In this way, a shift in the color temperature is avoided by setting the color temperature and the screen brightness correspondingly, such that the adjustment result of the color temperature conforms to the expectation, thus improving visual experience of the user.

In order to achieve the above embodiments, the present disclosure further provides a non-temporary computer readable storage medium having a computer program stored thereon. When the computer program is executed by a processor, the method for adjusting color temperature based on screen brightness mentioned above can be realized.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. In this specification, exemplary descriptions of aforesaid terms are not necessarily referring to the same embodiment or example. Furthermore, the particular features, structures, materials, or characteristics may be combined in any suitable manner in one or more embodiments or examples. Moreover, those skilled in the art could combine different embodiments or different characteristics in embodiments or examples described in the present disclosure.

Moreover, terms of “first” and “second” are only used for description and cannot be seen as indicating or implying relative importance or indicating or implying the number of the indicated technical features. Thus, the features defined with “first” and “second” may comprise or imply at least one of these features. In the description of the present disclosure, “a plurality of” means two or more than two, unless specified otherwise.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, wherein the order of execution may differ from that which is depicted or discussed, including according to involved function, executing concurrently or with partial concurrence or in the contrary order to perform the function, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of acquiring the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer-readable medium comprise but are not limited to: an electronic connection (an electronic device) with one or more wires, a portable computer enclosure (a magnetic device), a random access memory (RAM), a read-only memory (ROM), an erasable programmable read-only memory (EPROM or a flash memory), an optical fiber device and a portable compact disk read-only memory (CDROM). In addition, the computer-readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method for the present disclosure may be achieved by commanding the related hardware with programs, the programs may be stored in a computer-readable storage medium, and the programs comprise one or a combination of the steps in the method embodiments of the present disclosure when running on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer-readable storage medium.

The storage medium mentioned above may be read-only memories, magnetic disks, CD, etc.

Although embodiments of present disclosure have been shown and described above, it should be understood that above embodiments are just explanatory, and cannot be construed to limit the present disclosure, for those skilled in the art, changes, alternatives, and modifications can be made to the embodiments without departing from spirit, principles and scope of the present disclosure.

What is claimed is:

1. A method for adjusting color temperature based on screen brightness, comprising:
detecting a screen brightness of a screen subjected to a blue light filtering operation;
determining a reconstruction proportion of RGB optical spectral energy corresponding to the screen brightness and a target color temperature to be met according to pre-learned RGB optical spectral energy distribution information; and
adjusting the RGB optical spectral energy of the screen according to the reconstruction proportion, so as to make the RGB optical spectral energy of the screen subjected to the blue light filtering operation meet the target color temperature.

2. The method according to claim 1, wherein determining the reconstruction proportion of the RGB optical spectral energy corresponding to the screen brightness and the target color temperature to be met according to the pre-learned RGB optical spectral energy distribution information comprises:
acquiring a screen brightness level corresponding to the screen brightness; and
querying the pre-learned RGB optical spectral energy distribution information to acquire the reconstruction proportion corresponding to the screen brightness level and the target color temperature.

3. The method according to claim 1, wherein determining the reconstruction proportion of the RGB optical spectral energy corresponding to the screen brightness and the target color temperature to be met according to the pre-learned RGB optical spectral energy distribution information comprises:
querying a plurality of brightness ranges partitioned in advance, so as to determine a target brightness range including the screen brightness and a reference brightness corresponding to the target brightness range; and
querying the pre-learned RGB optical spectral energy distribution information to acquire the reconstruction proportion corresponding to the reference brightness and the target color temperature.

4. The method according to claim 1, wherein the method further comprises:
for each screen brightness level, pre-learning and storing a reconstruction proportion of the RGB optical spectral energy required for realizing a desired display effect of each color temperature so as to acquire the pre-learned RGB optical spectral energy distribution information.

5. The method according to claim 4, wherein for each screen brightness level, pre-learning and storing a reconstruction proportion of the RGB optical spectral energy required for realizing a display effect of each color temperature so as to acquire the pre-learned RGB optical spectral energy distribution information comprises:
for a predetermined screen brightness level, adjusting the RGB optical spectral energy of the screen in the initial state according to a predetermined color temperature;
acquiring a current color temperature according to the adjusted RGB optical spectral energy of the screen and determining whether the current color temperature meets the predetermined color temperature; and
when the current color temperature does not meet the predetermined color temperature, continuing adjusting the adjusted RGB optical spectral energy until the predetermined color temperature is met;
recording test data in the pre-learned RGB optical spectral energy distribution information, wherein the test data comprises: a correspondence between the predetermined screen brightness level, the predetermined color temperature and a reconstruction proportion of the RGB optical spectral energy.

6. The method according to claim 4, wherein for each screen brightness level, pre-learning and storing a reconstruction proportion of the RGB optical spectral energy required for realizing a display effect of each color temperature so as to acquire the pre-learned RGB optical spectral energy distribution information comprises:
presenting a display effect of a color temperature for a reconstruction proportion of the RGB optical spectral energy to a user for a predetermined screen brightness level;
receiving evaluation information fed back by the user to the display effect; and
recording test data in the RGB optical spectral energy distribution information according to the evaluation information, wherein the test data comprises: a correspondence between the predetermined screen brightness level, the first color temperature and the proportion of the RGB optical spectral energy.

7. The method according to claim 3, wherein the method further comprises:
detecting a screen brightness range;
determining the plurality of brightness ranges according to a predetermined number of ranges and the screen brightness range; and
determining a reference brightness corresponding to each brightness range.

8. The method according to claim 7, wherein determining the reference brightness corresponding to each brightness range comprises:
for each brightness range, acquiring a middle brightness in the brightness range as the reference brightness corresponding to the brightness range.

9. The method according to claim 1, wherein adjusting the RGB optical spectral energy of the screen according to the reconstruction proportion, so as to make the RGB optical spectral energy of the screen subjected to the blue light filtering operation meet the target color temperature comprises:
performing, by a plurality of first energy adjusting modules corresponding respectively to blue light, green light and red light, an initial adjustment on the RGB optical spectral energy according to the reconstruction proportion; and
performing, by a plurality of second energy adjusting modules corresponding respectively to blue light, green light and red light, a further adjustment on the RGB optical spectral energy initially adjusted by the first energy adjusting module, so as to make the RGB optical spectral energy of the screen subjected to the blue light filtering operation meet the target color temperature.

10. The method according to claim 1, wherein adjusting the RGB optical spectral energy of the screen according to the reconstruction proportion, so as to make the RGB optical spectral energy of the screen subjected to the blue light filtering operation meet the target color temperature comprises:
adjusting, by a plurality of third energy adjusting modules corresponding respectively to blue light, green light and red light, the RGB optical spectral energy of the screen according to the reconstruction proportion, so as to make the RGB optical spectral energy of the screen subjected to the blue light filtering operation meet the target color temperature.

11. The method according to claim 1, wherein detecting a screen brightness of a screen subjected to a blue light filtering operation comprises:
acquiring a proportion of filtered blue light;
substituting the proportion of filtered blue light into a screen brightness formula to acquire the screen brightness.

12. The method according to claim 1, wherein detecting a screen brightness of a screen subjected to a blue light filtering operation comprises:
acquiring the screen brightness using a brightness sensor.

13. A non-transitory computer-readable storage medium, having a computer program stored thereon, wherein when the computer program is executed by a device, the device is caused to perform a method for adjusting color temperature based on screen brightness, comprising:
detecting a screen brightness of a screen subjected to a blue light filtering operation;
determining a reconstruction proportion of RGB optical spectral energy corresponding to the screen brightness and a target color temperature to be met according to pre-learned RGB optical spectral energy distribution information; and
adjusting the RGB optical spectral energy of the screen according to the reconstruction proportion, so as to make the RGB optical spectral energy of the screen subjected to the blue light filtering operation meet the target color temperature.

14. The non-transitory computer-readable storage medium according to claim 13, wherein determining the reconstruction proportion of the RGB optical spectral energy corresponding to the screen brightness and the target color temperature to be met according to the pre-learned RGB optical spectral energy distribution information comprises:
acquiring a screen brightness level corresponding to the screen brightness; and
querying the pre-learned RGB optical spectral energy distribution information to acquire the reconstruction proportion corresponding to the screen brightness level and the target color temperature.

15. The non-transitory computer-readable storage medium according to claim 13, wherein determining the reconstruction proportion of the RGB optical spectral energy corresponding to the screen brightness and the target color temperature to be met according to the pre-learned RGB optical spectral energy distribution information comprises:
querying a plurality of brightness ranges partitioned in advance, so as to determine a target brightness range including the screen brightness and a reference brightness corresponding to the target brightness range; and
querying the pre-learned RGB optical spectral energy distribution information to acquire the reconstruction proportion corresponding to the reference brightness and the target color temperature.

16. The non-transitory computer-readable storage medium according to claim 13, wherein the method further comprises:
for each screen brightness level, pre-learning and storing a reconstruction proportion of the RGB optical spectral energy required for realizing a desired display effect of each color temperature so as to acquire the pre-learned RGB optical spectral energy distribution information.

17. The non-transitory computer-readable storage medium according to claim 16, wherein for each screen brightness level, pre-learning and storing a reconstruction proportion of the RGB optical spectral energy required for realizing a display effect of each color temperature so as to acquire the pre-learned RGB optical spectral energy distribution information comprises:
for a predetermined screen brightness level, adjusting the RGB optical spectral energy of the screen in the initial state according to a predetermined color temperature;
acquiring a current color temperature according to the adjusted RGB optical spectral energy of the screen and determining whether the current color temperature meets the predetermined color temperature; and
when the current color temperature does not meet the predetermined color temperature, continuing adjusting the adjusted RGB optical spectral energy until the predetermined color temperature is met;
recording test data in the pre-learned RGB optical spectral energy distribution information, wherein the test data comprises: a correspondence between the predetermined screen brightness level, the predetermined color temperature and a reconstruction proportion of the RGB optical spectral energy.

18. The non-transitory computer-readable storage medium according to claim 16, wherein for each screen brightness level, pre-learning and storing a reconstruction proportion of the RGB optical spectral energy required for realizing a display effect of each color temperature so as to acquire the pre-learned RGB optical spectral energy distribution information comprises:
presenting a display effect of a color temperature for a reconstruction proportion of the RGB optical spectral energy to a user for a predetermined screen brightness level;
receiving evaluation information fed back by the user to the display effect; and
recording test data in the RGB optical spectral energy distribution information according to the evaluation information, wherein the test data comprises: a correspondence between the predetermined screen brightness level, the first color temperature and the proportion of the RGB optical spectral energy.

19. The non-transitory computer-readable storage medium according to claim 13, wherein adjusting the RGB optical spectral energy of the screen according to the reconstruction proportion, so as to make the RGB optical spectral energy of the screen subjected to the blue light filtering operation meet the target color temperature comprises:
performing, by a plurality of first energy adjusting modules corresponding respectively to blue light, green light and red light, an initial adjustment on the RGB optical spectral energy according to the reconstruction proportion; and
performing, by a plurality of second energy adjusting modules corresponding respectively to blue light, green light and red light, a further adjustment on the RGB optical spectral energy initially adjusted by the first energy adjusting module, so as to make the RGB optical spectral energy of the screen subjected to the blue light filtering operation meet the target color temperature.

20. A terminal device, comprising a memory, a processor, and a computer program stored on the memory and executable on the processor, wherein when the processor executes the computer program, the terminal device is caused to perform operations comprising:
detecting a screen brightness of a screen subjected to a blue light filtering operation;
determining a reconstruction proportion of RGB optical spectral energy corresponding to the screen brightness and a target color temperature to be met according to pre-learned RGB optical spectral energy distribution information; and
adjusting the RGB optical spectral energy of the screen according to the reconstruction proportion, so as to make the RGB optical spectral energy of the screen subjected to the blue light filtering operation meet the target color temperature.
